(19) United States
(12) Patent Application Publication
(10) Pub. No.: US 2026/0349173 A1
(43) Pub. Date: Nov. 5, 2026

(54) DUAL LAYER POLARIZATION SPLITTER ROTATOR

(71) Applicant: Cisco Technology, Inc., San Jose, CA (US)

(72) Inventor: Jean-Luc J. TAMBASCO, Macungie, PA (US)

(21) Appl. No.: 19/195,638

(22) Filed: Apr. 30, 2025

(51) Int. Cl. G02B 6/126; G02B 6/122

(52) U.S. Cl. CPC G02B 6/126; G02B 6/1228

(57) ABSTRACT

Aspects of the present disclosure relate to polarization splitter rotators (PSRs) that allow for improved efficiency in converting input optical signals into desired polarizations. Embodiments include a pair of substantially parallel waveguides comprising a first waveguide and a second waveguide disposed in a substrate at a first layer, each waveguide of the pair of waveguides having a width that gradually increases along a direction from a first end to a second end. Embodiments further include a third waveguide disposed in the substrate at a second layer substantially parallel to a gap between the first waveguide and the second waveguide, the third waveguide having a first end, a second end, and a width that narrows at a particular distance from the first end and the second end.

### TECHNICAL FIELD

Embodiments presented in this disclosure generally relate to photonic polarization splitter rotators (PSRs). More specifically, embodiments disclosed herein relate to an improved compact PSR design that minimizes signal loss.

### BACKGROUND

In the field of photonic integrated circuits (PICs), polarization splitter rotators (PSRs) are a fundamental component that are used to rotate the polarization state of input optical signals. In other words, a PSR may convert the components of an optical signal from an undesired polarization to a desired polarization. For example, a PSR may be used to convert a signal that includes both transverse magnetic modes (e.g., TM0) and transverse electric modes (e.g., TE0) into one or more signals that include only transverse electric modes (e.g., TE0 and TE1).

However, existing PSRs may be highly inefficient, as much of the input signals may be lost during the rotation process. As a result, PSRs as known in the art may significantly limit the performance of optical devices. Also, existing PSRs may have large dimensions, which limits the amount of space in a device that is available for other components.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example polarization splitter rotator (PSR) according to certain embodiments of the present disclosure.

FIG. 2 depicts an example of functionality associated with PSRs according to certain embodiments of the present disclosure.

FIG. 3A depicts additional example PSRs according to certain embodiments of the present disclosure.

FIG. 3B depicts additional example PSRs according to certain embodiments of the present disclosure.

FIG. 3C depicts additional example PSRs according to certain embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

In one embodiment presented in this disclosure, a polarization splitter rotator (PSR) comprises: a pair of substantially parallel waveguides comprising a first waveguide and a second waveguide disposed in a first layer, each waveguide of the pair of waveguides having a width that gradually increases along a direction from a first end to a second end; and a third waveguide disposed at a second layer such that the third waveguide is substantially parallel to a gap between the first waveguide and the second waveguide, the third waveguide having a width that increases and then decreases along a length of the third waveguide.

In one embodiment presented in this disclosure, a PSR comprises: a substrate; and a pair of substantially parallel waveguides comprising a first waveguide and a second waveguide disposed in the substrate at a first layer, each waveguide of the pair of waveguides comprising: a first end with a width of around 400 nm to around 500 nm; a second end with a width of around 850 nm to around 950 nm; a middle portion between the first end and the second end with a width that gradually increases from around 400 nm adjacent to the first end to around 950 nm adjacent to the second end; and wherein a gap between the first waveguide and the second waveguide measures from about 450 nm to about 550 nm; and a third waveguide disposed in the substrate at a second layer, wherein the third waveguide is substantially parallel to the gap, wherein the third waveguide comprises: a first end with a width of around 50 nm to around 150 nm; a second end with a width of around 50 nm to around 150 nm; and a middle portion between the first end of the third waveguide and the second end of the third waveguide with a width that: increases from around 50 nm adjacent to the first end of the third waveguide to around 850 nm adjacent to a midpoint of the third waveguide; and decreases from around 850 nm adjacent to the midpoint to around 50 nm adjacent to the second end of the third waveguide.

In one embodiment presented in this disclosure, a PSR comprises: a pair of substantially parallel waveguides comprising a first waveguide and a second waveguide disposed in a first layer, wherein each waveguide of the pair of waveguides is tapered to split an input optical signal and rotate a component of the input optical signal from a first mode to a second mode; and a third waveguide disposed at a second layer such that the third waveguide is substantially parallel to a gap between the first waveguide and the second waveguide, wherein the third waveguide is tapered to split an input optical signal and rotate a component of the input optical signal from the first mode to the second mode.

### EXAMPLE EMBODIMENTS

In some embodiments, a polarization splitter rotator (PSR) comprises three waveguides disposed within a substrate. The waveguides may comprise a material such as silicon nitride, crystalline silicon, and/or poly-silicon. The substrate may include a material such as silicon dioxide. The thickness of the waveguides may measure between around 200 nm to around 300 nm. A pair of waveguides may be disposed in a first layer of the substrate. The pair of waveguides may be oriented substantially parallel along the length of the substrate. The gap between the pair of waveguides may measure between around 450 nm to around 550 nm. The waveguides may be tapered to insert the function of a PSR (which may be, for example, to split an input optical signal and rotate a component of the input optical signal from a first mode to a second mode). As an example, the width of each waveguide of the pair may gradually increase along the length of the substrate. In some embodiments, the width may measure between around 400 nm to around 500 nm near the first end of each of the waveguides, and the width may gradually increase until reaching around 850 nm to around 950 nm near the second end of each of the waveguides. The third waveguide may be disposed at a different layer of the substrate (e.g., a layer above or below the layer on which the pair of waveguides are disposed). The width of the third waveguide may taper at each end to insert the function of a PSR (which, as described above, may be to split an input optical signal and rotate a component of the input optical signal from a first mode to a second mode). For example, the width of a middle portion of the third waveguide may measure between around 750 nm to around 850 nm, while the width near the ends of the third waveguide may decrease to a range of around 50 nm to around 150 nm. A gap between the third waveguide and a plane on which the pair of waveguides is disposed may measure from around 50 nm to around 150 nm.

Embodiments of the present disclosure provide numerous technical and practical effects and benefits. Particularly, when optical signals are passed through PSRs as disclosed herein, components of the signals may be converted from undesired polarizations to desired polarizations much more efficiently (e.g., with much lower levels of signal loss) than may be achieved with prior art PSRs. Furthermore, in comparison with PSRs that achieve similar levels of performance, the PSRs disclosed herein may be much smaller, and thus may occupy much less space within an optical device. For example, while some existing PSRs may be able to approach the efficiency of PSRs disclosed herein, these PSRs may be much longer than the PSRs of embodiments of the present disclosure. For example, the PSRs disclosed herein may measure as low as 75 μm in length, whereas prior art PSRs with similar signal conversion efficiency may measure in excess of 500 μm in length.

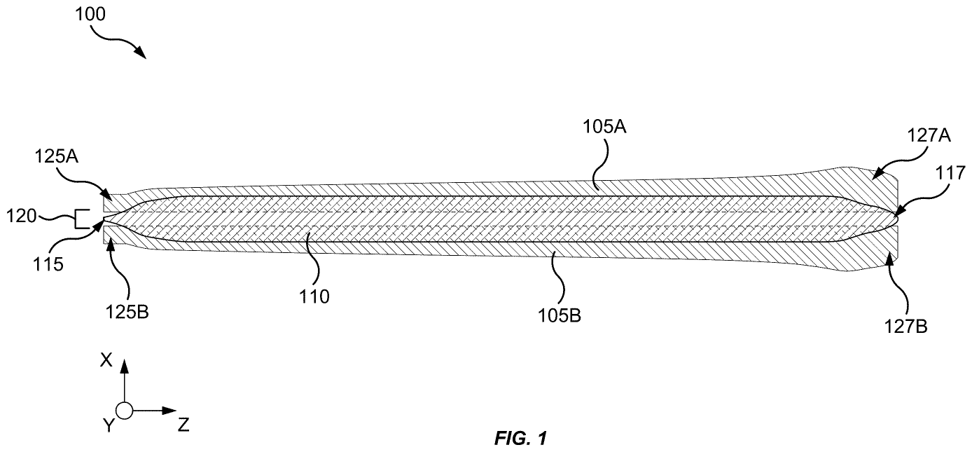

FIG. 1 depicts a plan view of an example polarization splitter rotator (PSR) 100 according to certain embodiments of the present disclosure.

The PSR 100 includes three waveguides. Each waveguide may have a thickness (measured along the y axis) of around 200 nm to around 300 nm. Each waveguide may include silicon nitride (Si₃N₄), crystalline silicon, poly-silicon, and/or similar materials as known in the art. The waveguides may be disposed within a substrate. For example, the substrate may surround each of the waveguides. The substrate may include silicon dioxide (SiO₂) and/or similar materials as known in the art. The waveguides may be disposed at different layers of the substrate.

In the example PSR 100 shown in FIG. 1, a first layer includes a pair of waveguides 105A and 105B. These waveguides 105A and 105B are separated by a gap 120. The gap 120 may measure between around 450 nm to around 550 nm (along the x axis). Waveguide 105A may have a first end 125A and waveguide 105B may have a first end 125B. Waveguide 105A may have a second end 127A and waveguide 105B may have a second end 127B. Each of the waveguides 105A and 105B may be tapered to insert the function of a PSR (which may be, for example, to split an input optical signal and rotate a component of the input optical signal from a first mode to a second mode). For example, for each of the waveguides 105A and 105B, the width (measured along the x axis) may gradually increase (or inverse taper) along a direction from the first end 125 to the second end 127. For instance, near the first end 125, each waveguide 105A and 105B may have a width measuring from around 400 nm to around 500 nm (e.g., the width of waveguide 105A at the first end 125A may be 450 nm). Near the second end 127, the width of each waveguide 105A and 105B may measure from around 850 nm to around 950 nm (e.g., the width of waveguide 105A at the first end 127A may be 900 nm). At points along the length of the waveguides 105A and 105B between the ends 125 and 127, the width of the waveguides 105A and 105B may be greater than the width near ends 125 and less than the width near ends 127.

In some embodiments, after reaching a maximum width at a given distance from end 127, the width may decrease until the end 127 is reached. As shown in FIG. 1, the width of the waveguides 105A and 105B reaches a maximum at a particular distance before the ends 127A and 127B (e.g., the particular distance may be 10 μm or less). Then, the width decreases to around 750 nm to around 850 nm near the ends 127A and 127B. Certain embodiments provide that at a particular distance from the ends 127A and 127B, the width remains constant until the ends 127A and 127B are reached.

According to some embodiments, the waveguides 105A and 105B may be disposed within a single layer of the PSR 100 (and not other layers). Thus, the input to each waveguide 105A and 105B may be provided to a layer, and the output may come from the same layer. This “same” layer may otherwise be referred to as a “common layer,” meaning that the input and output are disposed at a single, common layer of the PSR 100.

The PSR 100 includes a third waveguide 110 disposed at a second layer of the PSR 100. As shown in this example, the third waveguide 110 is disposed in a layer that is above the pair of waveguides 105A and 105B, although the third waveguide 110 may alternatively be disposed in a layer that is below the pair of waveguides 105A and 105B. The different layers may be planes within the waveguide. The distance between the third waveguide 110 and the plane that contains the pair of waveguides 105A and 105B may measure between about 50 nm and about 150 nm in the Y direction. The third waveguide 110 may be disposed above and parallel to a center axis between the pair of waveguides 105A and 105B.

The third waveguide 110 may have a first end 115, a second end 117, and a center portion between the first end 115 and the second end 117. The center portion may have a width of around 750 nm to around 850 nm. Near the first end 115 and the second end 117, the width of the third waveguide 110 may taper to insert the function of a PSR (which may be, for example, to split an input optical signal and rotate a component of the input optical signal from a first mode to a second mode). For example, near the first end 115 of the third waveguide 110, the width narrows to a range of around 50 nm to around 150 nm at the first end 115. Similarly, near the second end 117 of the third waveguide 110, the width narrows to a range of around 50 nm to around 150 nm at the second end 117.

In certain embodiments, the third waveguide 110 narrows at a given distance before the first end 115 and the second end 117. Then, the width may remain constant until the ends 115 and 117 are reached. In other words, the third waveguide may narrow at a given distance before the first end 115 and a particular distance before the second end 117 and then remain a constant width until the ends 115 and 117. In some embodiments, the given and particular distances each measure around 1μm or less, meaning that the third waveguide 110 narrows near each end 115 and 117.

In certain embodiments, the rate at which the width of a waveguide increases and/or decreases may be linear or may be represented as a varying continuous function. Some embodiments provide that the rate at which the width of a waveguide increases and/or decreases is calculated using an approach like that described in Dominic F. Siriani and Jean-Luc Tambasco, Adiabatic guided wave optics-a toolbox of generalized design and optimization methods, Opt. Express 29, 3243-3257 (2021) which is herein incorporated by reference. Certain embodiments provide that the rate at which the width of a waveguide increases and/or decreases is calculated using an approach like that described in Dominic F. Siriani and Jean-Luc Tambasco, Expanding the adiabatic design toolbox-more modes, parameters and versatility, Opt. Express 31, 41987-41995 (2023) which is herein incorporated by reference.

The total length of the PSR 100 (measured along the z axis) may, in some embodiments, be between around 75 μm to around 600 μm in length. For example, in some embodiments the length measures between around 250 μm to around 450 μm. As another example, in certain embodiments the total length of the PSR 100 measures from around 75 μm to around 150 μm.

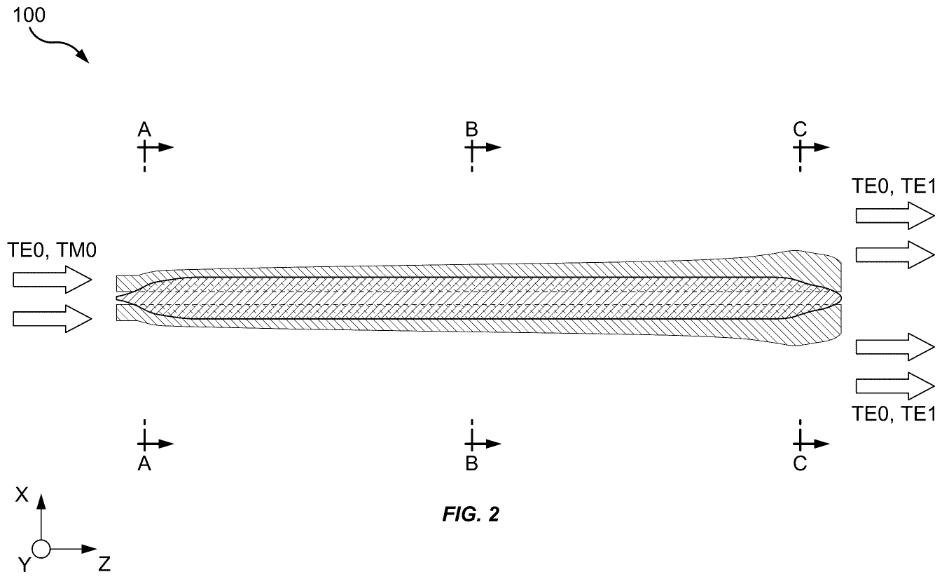

FIG. 2 depicts an example of functionality associated with the PSR 100.

An optical signal including a transverse electric mode TE0 and a transverse magnetic mode TM0 is provided as input to the PSR 100. As the optical signal passes through the PSR 100, the TM0 component of the signal is rotated into a TE1 component. Two signals are output from the PSR 100. Each signal includes both a TE0 component and a TE1 component. Thus, both signals output by the PSR 100 include only transverse electric mode components (and not transverse magnetic mode components).

In some embodiments, an adiabatic coupler as known in the art may be placed at the output of the PSR 100. The adiabatic coupler may be used to separate the TE0 component and the TE1 component such that the TE0 component and the TE1 component are transmitted in entirely separate signals.

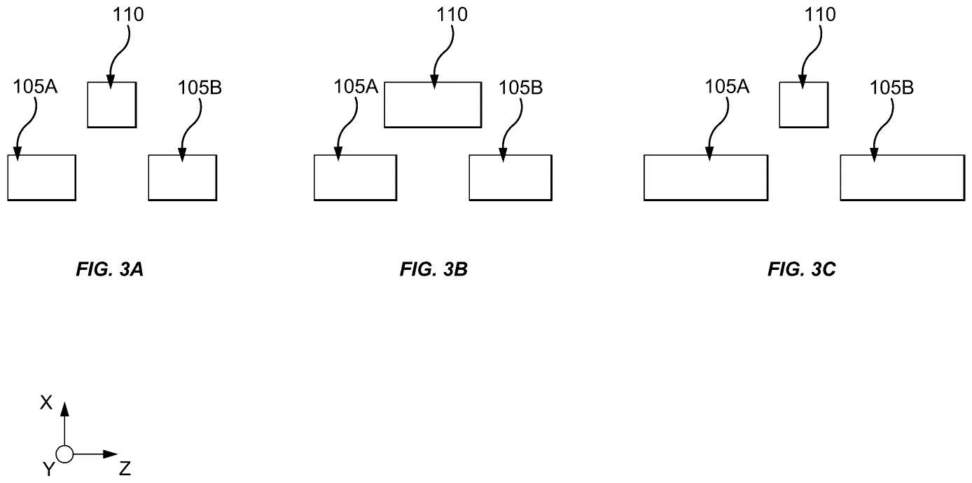

FIG. 3A-C depict example cross-sectional views of the PSR 100. In each view, each of the waveguides has a thickness (measured along the y axis) of around 200 nm to around 300 nm.

In FIG. 3A, cross-section A-A of FIG. 2 is shown. For the pair of waveguides 105A and 105B, each first end measures (along the x axis) between around 400 nm to around 500 nm. A gap between the pair of waveguides 105A and 105B measures (along the x axis) between around 450 nm to around 550 nm. The third waveguide 110, disposed at a different layer than the pair of waveguides 105A and 105B, is between around 50 nm and around 150 nm (measured along the y axis) above the pair of waveguides 105A and 105B. The waveguides may be surrounded by the substrate (e.g., the gaps between the waveguides may be filled by the substrate). The third waveguide 110 may have a width between around 50 nm to around 150 nm (measured along the x axis).

In FIG. 3B, cross-section B-B of FIG. 2 is shown. This cross-sectional view depicts the middle of the PSR 100. The middle of each of the pair of waveguides 105A and 105B has a width that is wider than the width of the first end of the pair of waveguides 105A and 105B but narrower than the width of the second end of the pair of waveguides 105A and 105B. A gap between the pair of waveguides 105A and 105B measures (along the x axis) between around 450 nm to around 550 nm. The third waveguide 110, disposed at a different layer than the pair of waveguides 105A and 105B, is between around 50 nm and around 150 nm (measured along the y axis) above the pair of waveguides 105A and 105B. The third waveguide 110 may have a width between around 750 nm to around 850 nm (measured along the x axis).

In FIG. 3C, cross-section C-C of FIG. 2 is shown. The second end of each of the pair of waveguides 105A and 105B measures (along the x axis) between around 850 nm to around 950 nm. A gap between the pair of waveguides 105A and 105B measures (along the x axis) between around 450 nm to around 550 nm. The third waveguide 110, disposed at a different layer than the pair of waveguides 105A and 105B, is between around 50 nm and 150 nm (measured along the y axis) above the pair of waveguides 105A and 105B. The third waveguide 110 may have a width between around 50 nm to around 150 nm (measured along the x axis).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A polarization splitter rotator (PSR), comprising:
a pair of substantially parallel waveguides comprising a first waveguide and a second waveguide disposed in a first layer, each waveguide of the pair of waveguides having a width that gradually increases along a direction from a first end to a second end; and
a third waveguide disposed at a second layer such that the third waveguide is substantially parallel to a gap between the first waveguide and the second waveguide, the third waveguide having a width that increases and then decreases along a length of the third waveguide.

2. The PSR of claim 1, wherein, for each waveguide, an input and an output are disposed at a common layer.

3. The PSR of claim 1, wherein, for each waveguide of the pair of substantially parallel waveguides, each second end is disposed adjacent to the other second end.

4. The PSR of claim 1, wherein:
the first end of each waveguide of the pair of waveguides has a width of around 400 nm to around 500 nm;
the second end of each waveguide of the pair of waveguides has a width of around 850 nm to around 950nm; and
for each waveguide of the pair of waveguides, a middle portion between the first end and the second end has a width that gradually increases from around 400 nm adjacent to the first end to around 950nm adjacent to the second end.

5. The PSR of claim 1, wherein a gap between the first waveguide and the second waveguide measures from about 450 nm to about 550 nm.

6. The PSR of claim 1, wherein the third waveguide has a first end and a second end, and:
the width of the third waveguide narrows at a given distance from the first end, wherein the given distance ranges from 0 nm to about 1 μm; and
the width of the third waveguide narrows at a particular distance from the second end, wherein the particular distance ranges from 0 nm to about 1 μm.

7. The PSR of claim 1, wherein the third waveguide comprises:
a first end with a width of around 50 nm to around 150 nm;
a second end with a width of around 50 nm to around 150 nm; and
a middle portion between the first end and the second end with a width of around 750 nm to around 850 nm.

8. The PSR of claim 7, wherein the width of the middle portion:
increases from around 50 nm adjacent to the first end to around 850 nm adjacent to a midpoint of the third waveguide; and
decreases from around 850 nm adjacent to the midpoint to around 50 nm adjacent to the second end.

9. The PSR of claim 7, wherein the first waveguide, the second waveguide, and the third waveguide each have a thickness of around 200 nm to around 300 nm.

10. A polarization splitter rotator (PSR), comprising:
a substrate; and
a pair of substantially parallel waveguides comprising a first waveguide and a second waveguide disposed in the substrate at a first layer, each waveguide of the pair of waveguides comprising:
a first end with a width of around 400 nm to around 500 nm;
a second end with a width of around 850 nm to around 950 nm;
a middle portion between the first end and the second end with a width that gradually increases from around 400 nm adjacent to the first end to around 950 nm adjacent to the second end; and
wherein a gap between the first waveguide and the second waveguide measures from about 450 nm to about 550 nm; and
a third waveguide disposed in the substrate at a second layer, wherein the third waveguide is substantially parallel to the gap, wherein the third waveguide comprises:
a first end with a width of around 50 nm to around 150 nm;
a second end with a width of around 50 nm to around 150 nm; and
a middle portion between the first end of the third waveguide and the second end of the third waveguide with a width that:
increases from around 50 nm adjacent to the first end of the third waveguide to around 850 nm adjacent to a midpoint of the third waveguide; and
decreases from around 850 nm adjacent to the midpoint to around 50 nm adjacent to the second end of the third waveguide.

11. The PSR of claim 10, wherein the first waveguide, the second waveguide, and the third waveguide each have a thickness of around 200 nm to around 300 nm.

12. A polarization splitter rotator (PSR), comprising:
a pair of substantially parallel waveguides comprising a first waveguide and a second waveguide disposed in a first layer; and
a third waveguide disposed at a second layer such that the third waveguide is substantially parallel to a gap between the first waveguide and the second waveguide, wherein each waveguide of the pair of waveguides and the third waveguide is tapered to split an input optical signal and rotate a component of an input optical signal from a first mode to a second mode.

13. The PSR of claim 12, wherein, for each waveguide, an input and an output are disposed at a common layer.

14. The PSR of claim 12, wherein each waveguide of the pair of waveguides has a width that gradually increases along a direction from a first end to a second end.

15. The PSR of claim 12, wherein the third waveguide has a first end, a second end, and a width that:
narrows at a given distance from the first end; and
narrows at a particular distance from the second end.

16. The PSR of claim 15, wherein:
the given distance ranges from 0 nm to about 1 μm; and
the particular distance ranges from 0 nm to about 1 μm.

17. The PSR of claim 12, wherein:
a first end of each waveguide of the pair of waveguides has a width of around 400 nm to around 500 nm;
a second end of each waveguide of the pair of waveguides has a width of around 850 nm to around 950 nm; and
for each waveguide of the pair of waveguides, a middle portion between the first end and the second end has a width that gradually increases from around 400 nm adjacent to the first end to around 950 nm adjacent to the second end.

18. The PSR of claim 12, wherein a gap between the first waveguide and the second waveguide measures from about 450 nm to about 550 nm.

19. The PSR of claim 12, wherein the third waveguide comprises:
a first end with a width of around 50 nm to around 150 nm;
a second end with a width of around 50 nm to around 150 nm; and
a middle portion between the first end and the second end with a width of around 750 nm to around 850 nm.

20. The PSR of claim 19, wherein the width of the middle portion:
increases from around 50 nm adjacent to the first end to around 850 nm adjacent to a midpoint of the third waveguide; and
decreases from around 850 nm adjacent to the midpoint to around 50 nm adjacent to the second end.
